(19) United States
(12) Patent Application Publication
(10) Pub. No.: US 2014/0269837 A1
(43) Pub. Date: Sep. 18, 2014

(54) APPARATUS, SYSTEMS, AND METHODS FOR MONITORING ELEVATED TEMPERATURES IN ROTATING COUPLINGS AND DRIVES

(71) Applicant: MagnaDrive Corporation, Woodinville, WA (US)

(72) Inventors: Dan Durland, Seattle, WA (US); Mike Tomczak, Stanwood, WA (US); Jeongkwan Lee, Houston, TX (US); Stephen Knudsen, Edmonds, WA (US)

(73) Assignee: MagnaDrive Corporation, Woodinville, WA (US)

(21) Appl. No.: 14/208,692

(22) Filed: Mar. 13, 2014

Related U.S. Application Data
(60) Provisional application No. 61/786,223, filed on Mar. 14, 2013.

(51) Int. Cl. G01K 7/02

(52) U.S. Cl. CPC G01K 7/02
USPC 374/179; 374/163

(57) ABSTRACT

A system to continuously and redundantly monitor a magnetic drive system includes temperature sensors coupled to the magnetic drive system. The temperature sensors are coupled to a transmitter, which generates output signals representing the temperatures of the temperature sensors. The system includes a transreceiver and a controller, where the transreceiver is coupled to the transmitter and configured to receive the output signals of the transmitter. The controller is communicatively coupled to the transreceiver and the magnetic drive system and is configured to control operation of the magnetic drive system based on one or more signals received from the transreceiver.

### CROSS-REFERENCE TO RELATED APPLICATION

This application claims the benefit under 35 U.S.C. §119(e) of U.S. Provisional Patent Application No. 61/786,223, filed Mar. 14, 2013, the contents of which are incorporated herein by reference in their entirety.

### BACKGROUND

1. Technical Field

The present disclosure relates to temperature monitoring apparatuses, systems, and methods and, more particularly, to temperature monitoring of magnetic drive systems.

2. Description of the Related Art

Magnetic drive systems, which may include fixed gap magnetic couplings and/or adjustable speed drive systems, operate by transmitting torque from a motor to a load across an air gap. There is no mechanical connection between the driving and driven sides of the equipment. Torque is created by the interaction of powerful rare-earth magnets on one side of the drive with induced magnetic fields on the other side. By varying the air gap spacing, as in adjustable speed drive systems, the amount of torque transmitted can be controlled, thus permitting speed control.

Magnetic drive systems typically include a magnetic rotor assembly and a conductor rotor assembly. The magnetic rotor assembly, containing rare-earth magnets, is attached to the load. The conductor rotor assembly is attached to the motor. The conductor rotor assembly includes a rotor made of a conductive material, such as aluminum, copper, or brass. In some magnetic drive systems, such as the adjustable speed drive systems, the magnetic drive system also includes actuation components, which control the air gap spacing between the magnet rotors and the conductor rotors.

Relative rotation of the conductor and magnet rotor assemblies induces a powerful magnetic coupling across the air gap. Varying the air gap spacing between the magnet rotors and the conductor rotors results in controlled output speed. The output speed is adjustable, controllable, and repeatable.

The principle of magnetic induction requires relative motion between the magnets and the conductors. This means that the output speed is always less than the input speed. The difference in speed is known as slip. Typically, slip during operation at a full rating motor speed is between 1% and 3%.

The relative motion of the magnets in relation to the conductor rotor causes eddy currents to be induced in the conductor material. The eddy currents in turn create their own magnetic fields. It is the interaction of the permanent magnet fields with the induced eddy current magnetic fields that allows torque to be transferred from the magnet rotor to the conductor rotor. The electrical eddy currents in the conductor material create electrical heating in the conductor material.

The generation of heat in magnetic drive systems, used in a wide variety of environments, in combination with equipment generating high amounts of energy, often leads to an explosive environment. Conventional methods involve estimating the heat generated based on the torque and speed characteristics of the driven side, i.e., the load side, and the operating speeds of the drive side, i.e., the motor side, and setting limiting temperatures. However, such conventional methods do not appropriately account for the unpredictable nature of magnetic drive systems with multiple moving parts. By way of example, in some instances, variability in the applications of use and their associated estimated loads can result in an inaccurate setting of limiting temperatures. In some instances, the load side may become jammed with a conveyor product, or other debris hindering movement of the load side, resulting in excessive amounts of heat being generated. In yet other instances, the estimated generation of heat may be inaccurate because the ambient temperature may be higher than anticipated.

### BRIEF SUMMARY

Embodiments described herein provide apparatuses, systems, and methods to continually monitor the temperature of magnetic drive systems in an accurate, efficient, and robust manner. In some embodiments, appropriate commands are provided to the magnetic drive systems in response to the temperatures exceeding defined temperature thresholds. The commands may include disabling a motor and/or adjusting the air gaps.

According to one embodiment, a system to monitor temperature of a magnetic drive system may be summarized as including a temperature sensor mounted on the magnetic drive system; a transmitter coupled to the temperature sensor; a transreceiver coupled to the transmitter; and a controller communicatively coupled to the transreceiver and the magnetic drive system. The transreceiver may generate a signal representing a temperature of the temperature sensor and the transreceiver may be configured to receive the signal. The controller may be configured to control operation of the magnetic drive system based on one or more signals received from the transreceiver.

According to another embodiment, a temperature monitoring system may be summarized as including a magnetic drive system, a plurality of thermocouples, a thermocouple transmitter, a transreceiver, and a controller. The magnetic drive system may include a conductor rotor assembly coupled to a motor shaft, the conductor rotor assembly including a pair of coaxial conductor rotors, the conductor rotors having a body comprised of non-ferrous electroconductive material; a magnetic rotor assembly coupled to a load shaft, the magnetic rotor assembly including a pair of magnet rotors each containing a respective set of magnets, wherein the magnet rotors are positioned between the pair of coaxial conductor rotors and spaced apart from the conductor rotors to define an air gap. The plurality of thermocouples may be mounted on the conductor rotors and the thermocouple transmitter may be coupled to the plurality of thermocouples, the thermocouple transmitter configured to generate a signal representing a temperature of a hot juncture of the respective thermocouple. Further, the transreceiver may be communicatively coupled to the thermocouple transmitter, and configured to receive the corresponding signal. The controller may be communicatively coupled to the transreceiver and the magnetic drive system and configured to continuously scan the transreceiver for the temperature of the respective thermocouple.

According to yet another embodiment, a method to monitor temperature of a magnetic drive system may be summarized as including measuring a temperature of the magnetic drive system; comparing the temperature with a threshold temperature; and sending a signal to the magnetic drive system in response to the comparison.

### BRIEF DESCRIPTION OF THE SEVERAL VIEWS OF THE DRAWINGS

FIG. 1 is a partial isometric view schematically illustrating a temperature monitoring system, according to one embodiment.

FIG. 2 is a front elevational view of the temperature monitoring system of FIG. 1, with certain components removed for clarity.

FIG. 3 is a cross-sectional view of the temperature monitoring system of FIG. 1, taken along lines 3-3.

FIG. 4 is a front elevational view of the temperature monitoring system of FIG. 1, with certain components removed for clarity.

FIG. 5 is a top elevational view of the temperature monitoring system of FIG. 1, with certain components removed for clarity.

FIG. 6 is a functional block diagram of components of a temperature monitoring system, according to one embodiment.

FIG. 7 is a partial isometric view of a temperature monitoring system, according to another embodiment.

FIG. 8 is a graph showing temperatures of a magnetic drive system during monitoring, according to one embodiment of a temperature monitoring system.

FIG. 9 is a graph showing temperatures of a magnetic drive system during monitoring, according to one embodiment of a temperature monitoring system.

### DETAILED DESCRIPTION

The following detailed description is directed toward apparatuses, systems, and methods for use in connection with monitoring temperatures of magnetic drive systems. The description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, to the extent they are within the scope of the associated claims.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

FIGS. 1-5 illustrate a temperature monitoring system 10, according to one embodiment, that advantageously continuously and redundantly monitors temperatures of a magnetic drive system 12. The magnetic drive system 12 includes a magnetic rotor assembly 14 and a conductor rotor assembly 16. The magnetic rotor assembly 14 includes a pair of magnet rotors 18. The magnet rotors 18 are spaced apart from each other, and one magnet rotor 18 is positioned proximal to a load shaft 20 and the other is positioned proximal to a motor shaft 22. Each of the magnet rotors 18 comprises a magnet disc 24 (e.g., a non-ferrous magnet disc) backed by a backing disc 26 (e.g., a ferrous backing disc). The magnet rotors 18 are mounted on the load shaft 20 and rotate in unison therewith. As best illustrated in FIG. 2, each of the magnet discs 24 of the respective magnet rotors 18 includes a plurality of a circular array of rectangular pockets 19 to receive therein a respective permanent magnet 21.

The conductor rotor assembly 16 is mounted on the motor shaft 22 of a motor 13, and rotates in unison therewith. The conductor rotor assembly 16 includes a pair of conductor rotors 30 that are spaced apart from each other by spacers 32. Each of the conductor rotors 30 includes end rings 34. Coupled to inward facing sides of the end rings 34 are conductor rings 36, 37. The conductor rings 36, 37 generally comprise non-ferrous material, such as copper, aluminum, brass, or other non-ferrous metals. The conductor rings 36, 37 are spaced apart from the respective magnet rotors 18 by air gaps 38. The air gap 38 may be a fixed air gap (e.g., FIG. 7) or may be an adjustable air gap. By way of example, some magnetic drive systems 12 may include an actuator assembly 39. The actuator assembly 39 is coupled to the magnetic rotor assembly 14 in a known manner. The actuator assembly 39 is configured to controllably move the magnet rotor assembly 14 with respect to the conductor rotor assembly 16, such that the air gaps 38 of the magnetic drive system 12 are adjustable. Moreover, while in the embodiment illustrated in FIGS. 1-5, the conductor rotor assembly 16 is mounted on the motor shaft 22 and the magnetic rotor assembly 14 is mounted on the load shaft 20, alternatively, the conductor rotor assembly 16 may be mounted on the load shaft 20 and the magnetic rotor assembly 18 may be mounted on the motor shaft 22. In this manner, the conductor rotors 30 may rotate in unison with the load shaft 20 and the magnet rotors 18 may rotate in unison with the motor shaft 22.

The magnetic drive system 12 further includes heat sink elements 40 that are coupled to the outwardly facing sides of the conductor rotor assemblies 16. The heat sink elements 40 may be coupled to the conductor rotor assemblies 16 via fastening, welding, adhering, or other suitable means.

As noted above, a magnetic drive system generally operates under the principal of slip. The electrical eddy currents in a conductor material create electrical heating therein. Using Lenz's Law, the amount of heat generated can be calculated as follows: Slip Heat=K*Torque*Slip Velocity, which results in: k*T*(ω_{M}−ω_{L}), wherein T is motor torque; ω_{M} is motor speed in Revolutions Per Minute (“RPM”); ω_{L} is output speed in RPM; and k is a constant to convert the shaft power into KW or any other power of units of choice). Notably, while the heat generated by magnetic drive systems may be estimated, such calculations neither account for the extraneous conditions and environments of operation, nor do such calculations account for the precise locations where the highest amount of heat is generated.

The temperature monitoring system 10 and other embodiments described herein advantageously continuously and redundantly monitor magnetic drive systems and provide appropriate commands in response to the measured temperatures. With continued reference to FIGS. 1-5, and as best illustrated in FIGS. 4-5, the temperature monitoring system 10 includes a plurality of temperature sensors 42. The temperature sensors 42 may comprise thermocouples, thermistors, resistance temperature detectors (“RTD”), and/or other temperature sensing devices. By way of a non-limiting example, the temperature monitoring system 10 illustrated in FIGS. 1-5 comprises thermocouples. However, other temperature sensing devices are within the scope of the present disclosure. The temperature sensors 42 are coupled to a transmitter 44 mounted on the magnetic drive system 12. The transmitter 44 overlies the heat sink elements 40 and is coupled to the respective end rings 34 through fasteners. In other embodiments, the transmitter 44 may be positioned at any other suitable position, and/or may be positioned remote from the magnetic drive system 12. The transmitter 44 includes a plurality of input connectors, which are configured for receiving the respective temperature sensor 42. By way of example, the transmitter 44 illustrated in FIGS. 1-5 includes six input connectors. Each of the six input connectors generally defines six channels isolated from each other, and configured to couple to a respective proximal end of the temperature sensor 42. It is appreciated, however, that the transmitter 44 may include any number of input connectors. Moreover, the input connectors can be configured to receive a wide variety of temperature sensors, such as J, K, N, R types of thermocouples, for example.

A distal end 46 of each temperature sensor 42 (e.g., 42a, 42b, 42c, 42d) is coupled to a location on the magnetic drive system 12 where the temperature is to be measured, which may commonly be referred to as a hot junction when the temperature sensor 42 comprises a thermocouple. As best illustrated in FIGS. 4-5, the distal ends 46 of the temperature sensors 42a, 42b, 42c, 42d are coupled to the conductor rings 36, 37. The distal ends 46 may be coupled to the conductor rings 36, 37 via soldering, adhering, fastening, or any other suitable means.

More particularly, the distal ends 46 of respective sensors 42a, 42b extend substantially midway through the thickness of the conductor ring 36, which is positioned on the motor 13 side of the magnetic drive system 12. In addition, the distal ends 46 are positioned substantially along a magnetic centerline 47. As best illustrated in FIGS. 2 and 3, the magnetic centerline 47 is defined by a coaxial ring that circumferentially follows a path defined by a centerline of the permanent magnets 21 of the respective magnet rotor discs 24, and is projected onto the conductor rings 36, 37. Similarly, the distal ends 46 of respective sensors 42c, 42d extend substantially midway through the thickness of the conductor ring 37 (i.e., load side) and along the magnetic centerline 47. Positioning the distal ends 46 in this manner, Applicant has discovered through experimentation, advantageously improves accuracy of the temperature readings of the magnetic drive system 12, as such locations present the locations of the highest temperatures of the magnetic drive system 12. Although the temperature sensors 42 illustrated in the embodiment of FIGS. 1-5 are located in the conductor rings 36, 37, in other embodiments, the temperature sensors 42 may be located in any other suitable location.

With continued reference to FIGS. 1-5, the temperature monitoring system 10 may include additional temperature sensors 42 to measure reference temperatures. By way of example, distal ends of additional temperature sensors may be coupled to other components of the magnetic drive system 12 to provide measurements of reference temperatures. The distal ends may be coupled to the respective backing discs 26 of the magnet rotors 18, or other components that may experience minimal heat generation, for example. The temperature monitoring system 10 may measure the ambient temperature to establish and compare temperatures of the conductor rotors 30 relative to the ambient temperatures. In this manner, the temperature monitoring system 10 can continuously measure and monitor the ambient temperatures in real-time, thus advantageously providing precise readings and also accounting for the uncertainty of the variable operational environments of magnetic drive systems.

The various temperatures measured by the temperature sensors 42 may provide input voltage signals representing the thermal gradient of the temperature differences between a cold junction and the hot junction, for example, when the temperature sensors 42 comprise thermocouples. Alternatively, resistance signals may be provided when the temperature sensors 42 comprise RTDs. In this manner, the transmitter 44 can process the respective signals to determine the temperatures and output corresponding signals.

The transmitter 44 is further coupled to a transreceiver 48. The transmitter 44 may be coupled to the transreceiver 48 wirelessly, as illustrated in the embodiment of FIGS. 1-5, or may be coupled through a wired connection in a known manner.

The transreceiver 48 is configured to be in electronic communication with the transmitter 44 and provides an interface between a controller 50 and the transmitter 44, such that the transreceiver 48 communicates the temperature measurements of the temperature sensors 42 to the controller 50. The transreceiver 48 may be coupled to the controller 50 wirelessly or through a wired connection, such as a USB cable, as illustrated in the embodiment of FIGS. 1-5. The controller 50 can include, without limitation, one or more processors, microprocessors, digital signal processors (DSPs), field programmable gate arrays (FGPA), and/or application-specific integrated circuits (ASICs), memory devices, buses, power sources, and the like. For example, the controller 50 can include a processor in communication with one or more memory devices. Buses can link an internal or external power supply to the processor. The memories may take a variety of forms, including, for example, one or more buffers, registers, random access memories (RAMs), and/or read only memories (ROMs). In some embodiments, the controller 50 can be communicatively coupled to an external device or system, such as a computer (e.g., a desktop computer, a laptop computer, etc.), a network (e.g., a local network, a WiFi network, or the like), or mobile device (e.g., a smartphone, a cellular phone, etc.). The controller 50 may also include a display, such as a screen, and an input device. The input device can include a keyboard, touchpad, or the like and can be operated by a user to control the temperature monitoring system 10.

In some embodiments, the controller 50 has a closed loop system or an open loop system. For example, the controller 50 can have a closed loop system, whereby the power to the motor 13 and consequently the motor shaft 22 is controlled based upon feedback signals from one or more temperature sensors 42 configured to transmit (or send) one or more signals indicative of one or more temperature characteristics, or any other measurable parameters of interest. Based on those readings, the controller 50 can then adjust operation of the motor 13. In some embodiments, the controller's 50 closed loop system may be configured to additionally and/or alternatively control the actuator assembly 39 and consequently the air gap 38 based upon feedback signals from one or more temperature sensors 42 configured to transmit (or send) one or more signals indicative of one or more temperature characteristics, or any other parameters of interest. Based on those readings, the controller 50 can then adjust operation of the actuator assembly 39. Alternatively, the temperature monitoring system 10 can be an open loop system wherein the operation of the motor 13 and/or the actuator assembly 39 is set by user input.

Additionally, the controller 50 can store different programs. A user can select a program that accounts for the characteristics of the temperature and the desired target temperature threshold. By way of example, the temperature threshold may be set based on a particular magnetic drive system and/or a particular motor. The controller 50 can execute a program to determine the threshold temperature based on the maximum torque of the magnetic drive system and the motor speed, including when the motor is jammed. In some embodiments, the threshold temperature is set based on the following equation:

Threshold Temperature=(maximum allowable temperature)−ΔT/Δt×ts

where ΔT/Δt is the temperature rise rate and is determined based on specific magnetic drive systems and motors' maximum possible speed; “ts” is the total response time of a temperature monitoring system; and maximum allowable temperature is the maximum temperature of a magnetic drive system, determined based on the magnetic drive system operating at full speed, maximum torque, and subsequently experiencing a load jam condition. In some embodiments, the threshold temperature may be set to be a certain percentage of the threshold temperature. By way of example, the threshold temperature may be set to be 60%-80% of the determined threshold temperature. In this manner, an additional protective buffer may advantageously be provided to the temperature monitoring system 10.

The controller 50 can be programmed to compare the temperature measurements of the various temperature sensors with the threshold temperature. By way of example, the controller 50 can execute a program to continuously scan the transreceiver 48 to determine the temperatures of the various temperature sensors 42. The controller 50 can execute a motor operation program to disable or remove power supply to the motor 13 when the temperature measurements exceed the threshold temperature or a selected percentage of the threshold temperature. The controller 50 can also be programmed to control the air gaps 38 between the magnet rotor assembly 14 and the conductor rotor assembly 16. The air gaps 38 can be adjusted by relative movement of the magnet rotors 18 and the conductor rotors 30 by means of the actuator assembly 39, or any other device.

FIG. 6 illustrates a functional block diagram showing use of the temperature monitoring system. The temperature monitoring system includes at least a sensing module 51, a controlling module 52, and response modules 56, 58. The sensing module 51 comprises a plurality of temperature sensors 42 coupled to the magnetic drive system 12. The temperature sensors 42 are communicatively coupled to the transmitter 44, which processes the corresponding signals to determine the temperature of the respective temperature sensors 42. The transmitter 44 is further coupled to the transreceiver 48. As discussed in more detail elsewhere, the transmitter 44 may be coupled wirelessly or through a wired connection to the transreceiver 48. In this manner, the transreceiver 48 receives one or more signals from the transmitter 44 representing the temperature of the magnetic drive system 12.

The controlling module 52 comprises the controller 50. The controller 50 is coupled to the transreceiver 48 and is in communication with the transreceiver 48. A processor and control circuitry of the controller 50 receives the signals from the transreceiver 48, representing the temperatures of the temperature sensors 42 mounted on the magnetic drive system 12. The processor uses the information to make comparisons of the temperatures of the magnetic drive system 12. More particularly, the processor compares the temperature of the magnetic drive system 12, represented by the plurality of temperature sensors 42, with the set threshold temperature.

If the temperature is above the threshold temperature or if no signal is received, under response module 56, the controller 50 commands one or more components of the motor 13 to disable operation of the motor 13 by sending a corresponding output signal. The motor 13 may be disabled in a wide variety of ways, such as by removing the power supply, disengaging certain components of the motor, or the like. Conversely, if the temperature is below the threshold temperature and if a signal is received, then the controller 50 commands one or more components of the motor 13 to continue operation which, in turn, transmits rotational forces to drive a load 60. In this manner, the temperature of a magnetic drive system can advantageously be continuously monitored and, when the temperature exceeds the set threshold, for example, in case of a jam, the temperature monitoring system 10 can disable operation of the motor 13 and prevent overheating of the magnetic drive system 12.

Alternatively or additionally, if the temperature is above the threshold temperature and/or if no signal is received, under response module 58, the controller 50 commands one or more components of the actuator assembly 39 to adjust the air gaps 38 of the magnetic drive system 12 by sending a corresponding output signal. More particularly, the controller 50 commands the actuator assembly 39 to axially move the magnet rotors 18 relative to the conductor rotors 30 to a maximum air gap position. In this manner, the rotational forces between the magnet rotors 18 and the conductor rotors 30 can be substantially eliminated, which, in turn, advantageously disables the magnetic drive system 12 and prevents overheating thereof.

FIG. 7 illustrates a temperature monitoring system 110, according to another embodiment. The temperature monitoring system 110 provides a variation in which a magnet rotor assembly 114 is fixedly positioned relative to a conductor rotor assembly 116. Thus, a controller 150 is configured to command one or more components of a motor 113 to continue operation when temperatures of the magnetic drive system 112 are below a set threshold temperature or a feedback signal is received from the temperature sensors 142. Conversely, the controller 150 is configured to command one or more components of the motor 113 to disable operation thereof when the temperatures exceed the threshold temperature and/or a feedback signal is not received from any of the temperature sensors 142.

FIG. 8 is a graph with a vertical axis corresponding to the temperatures measured in accordance with an embodiment of a temperature monitoring system. The temperature monitoring system is used in connection with a magnetic drive system having adjustable air gaps. As illustrated in FIG. 8, a temperature trigger was set at approximately 80% of the temperature threshold. When a temperature sensor (i.e., thermocouple 23) reached the set threshold temperature, a control module sent an output signal to disable a motor by removing the power supply to the motor. After a short lag, the temperatures were reduced as the motor speed decreased.

FIG. 9 is a graph with a vertical axis corresponding to the temperatures measured in accordance with an embodiment of a temperature monitoring system. The temperature monitoring system is used in connection with a magnetic drive system having fixed air gaps. As illustrated in FIG. 9, a temperature trigger was set at approximately 80% of the temperature threshold. When a temperature sensor (i.e., thermocouple 1) reached the set threshold temperature, a control module sent an output signal to disable a motor by removing the power supply to the motor. Again, after a short lag, the temperatures were reduced as the motor speed decreased.

The various embodiments described above can advantageously provide methods to continuously and redundantly monitor magnetic drive systems. By way of example, a method to monitor magnetic drive systems may comprise coupling one or more temperature sensors to the magnetic drive system. The temperature sensors may be coupled to a transmitter to process appropriate signals corresponding to the temperatures.

The method may comprise communicatively coupling a transreceiver to the transmitter and to a controller, wherein the transreceiver communicates the temperatures of the magnetic drive system to the controller. The method may further comprise setting a threshold temperature, comparing the temperatures with the set threshold temperature, and sending output signals in response to the comparison. In some embodiments, the output signal may represent commanding a motor coupled to the magnetic drive system to continue operation when the temperature is below the threshold temperature and when a feedback signal is received by the controller. In some embodiments, the output signal may represent disabling operation of the motor when the temperature is at or exceeds the threshold temperature. In some embodiments, the output signal may represent commanding the actuator to position the magnetic drive system to a maximum air gap position.

The method may further comprise coupling an indicator to the controller. The indicator may be configured to communicate to a user when the temperature exceeds the threshold temperature and/or when no feedback signal is received by the controller. The indicator may comprise an audible alarm, a buzzer, a gauge, and/or a light emitting diode (LED).

Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system to monitor temperature of a magnetic drive system, the system comprising:
a temperature sensor mounted on the magnetic drive system;
a transmitter coupled to the temperature sensor, the transmitter generating a signal representing a temperature of the temperature sensor;
a transreceiver coupled to the transmitter, the transreceiver configured to receive the signal; and
a controller communicatively coupled to the transreceiver and the magnetic drive system, the controller configured to control operation of the magnetic drive system based on one or more signals received from the transreceiver.

2. The system of claim 1 wherein the controller is configured to compare the temperature to a threshold temperature and command the magnetic drive system in response to the comparison of the temperature to the threshold temperature.

3. The system of claim 2 wherein the controller is configured to output a shutdown signal to the magnetic drive system when the temperature exceeds the threshold temperature.

4. The system of claim 2 wherein the controller is configured to output a shutdown signal to the magnetic drive system when no output signal is received by the transreceiver.

5. The system of claim 1, further comprising:
a plurality of thermocouples, the plurality of thermocouples mounted on a conductor rotor of the magnetic drive system, the plurality of thermocouples being mounted substantially along a magnetic centerline.

6. The system of claim 2 wherein the threshold temperature is set to 80 percent of a predefined temperature limit.

7. A temperature monitoring system comprising:
a magnetic drive system comprising:
a conductor rotor assembly coupled to a motor shaft, the conductor rotor assembly including a pair of coaxial conductor rotors, the conductor rotors having a body comprised of non-ferrous electroconductive material;
a magnetic rotor assembly coupled to a load shaft, the magnetic rotor assembly including a pair of magnet rotors each containing a respective set of magnets, wherein the magnet rotors are positioned between the pair of coaxial conductor rotors and spaced apart from the conductor rotors to define an air gap;
a plurality of thermocouples mounted on the conductor rotors;
a thermocouple transmitter coupled to the plurality of thermocouples, the thermocouple transmitter configured to generate a signal representing a temperature of a hot juncture of the respective thermocouple;
a transreceiver communicatively coupled to the thermocouple transmitter, the transreceiver configured to receive the corresponding signal; and
a controller communicatively coupled to the transreceiver and the magnetic drive system, the controller configured to continuously scan the transreceiver for the temperature of the respective thermocouple.

8. The temperature monitoring system of claim 7 wherein the transreceiver is wirelessly coupled to the transmitter.

9. The temperature monitoring system of claim 7 wherein the controller is configured to compare the temperatures of the thermocouples to a threshold temperature and command the magnetic drive system in response to the comparison of the temperature to the threshold temperature.

10. The temperature monitoring system of claim 9 wherein the controller is configured to send a shutdown signal to the magnetic drive system when at least one of the temperatures of the thermocouples exceeds the threshold temperature or the signal is not received by the transreceiver.

11. The temperature monitoring system of claim 9 wherein the magnetic drive system further comprises an actuator, the actuator being configured to axially displace the magnet rotors relative to the conductor rotors to adjust the air gap.

12. The temperature monitoring system of claim 11 wherein the controller is configured to send a shutdown signal to the magnetic drive system when at least one of the temperatures of the thermocouples exceeds the threshold temperature or the signal is not received by the transreceiver.

13. The temperature monitoring system of claim 12 wherein the shutdown signal commands the magnetic drive system to remove power supply to a motor driving the motor shaft.

14. The temperature monitoring system of claim 12 wherein the shutdown signal commands the actuator to displace the magnet rotors relative to the respective conductor rotors such that the air gap is increased to a maximum air gap configuration.

15. A method to monitor temperature of a magnetic drive system, the method comprising:
measuring a temperature of the magnetic drive system;
comparing the temperature with a threshold temperature; and
sending a signal to the magnetic drive system in response to the comparison.

16. The method of claim 15 wherein measuring the temperature comprises:
generating an output signal from a transmitter coupled to a transreceiver, the output signal representing a temperature of a temperature sensor coupled to the magnetic drive system.

17. The method of claim 15 wherein comparing the temperature comprises:
communicatively coupling a controller to a transreceiver, the transreceiver being configured to receive an output signal representing the temperature of the magnetic drive system; and
continuously scanning the transreceiver to compare the temperature of the magnetic drive system with the threshold temperature.

18. The method of claim 17, further comprising:
disabling the magnetic drive system when at least one of the temperature exceeds the threshold temperature or no output signal is received by the transreceiver; and
continuing operation of the magnetic drive system when the temperature is at or below the threshold temperature and the output signal is received by the transreceiver.

19. The method of claim 15, further comprising:
setting the threshold temperature.

20. The method of claim 19 wherein the threshold temperature is determined by the following equation:
Threshold Temperature=(Maximum Allowable Temperature)−Temperature Rise/Second×System Response Time.

21. The method of claim 15 wherein sending the signal comprises at least one of removing power supply to a motor coupled to the magnetic drive system and increasing an air gap of the magnetic drive system to a maximum air gap.

22. The method of claim 15 wherein measuring the temperature comprises:
coupling a plurality of thermocouples to the magnetic drive system;
coupling a transmitter to each of the respective thermocouple, the transmitter generating a signal representing the temperature of a hot juncture of the respective thermocouple; and
coupling a transreceiver to the transmitter, the transreceiver being configured to receive the signal.

23. The method of claim 22 wherein the plurality of thermocouples are coupled to the magnetic drive system along a magnetic centerline.

24. The method of claim 15, further comprising:
coupling an indicator to a controller, the controller being coupled to a receiver and configured to receive an output signal representing the temperature of the magnetic drive system; and
communicating to a user through the indicator when the temperature exceeds the threshold temperature.

25. The method of claim 24 wherein the indicator comprises at least one of an audible alarm, a buzzer, a gauge, and a light emitting diode (LED).
